(19) United States
(12) Patent Application Publication
(10) Pub. No.: US 2026/0063452 A1
(43) Pub. Date: Mar. 5, 2026

(54) VEHICULAR SENSOR MODULE WITH OVERMOLDED HOUSING STRUCTURE

(71) Applicant: Magna Electronics Inc., Auburn Hills, MI (US)

(72) Inventors: Christian Mai, Grossostheim (DE); Holger Hess, Hösbach (DE)

(21) Appl. No.: 19/311,087

(22) Filed: Aug. 27, 2025

Related U.S. Application Data
(60) Provisional application No. 63/689,066, filed on Aug. 30, 2024.

(51) Int. Cl. G01D 11/24; B29C 45/14; B29K 705/00; B29L 31/00; B29L 31/30; G01S 7/02; H04N 23/51; H04N 23/52

(52) U.S. Cl. CPC G01D 11/245; B29C 45/14336; B29C 45/14778; G01S 7/027; H04N 23/51; H04N 23/52; B29C 2045/14868; B29K 2705/00; B29K 2995/0013; B29L 2031/30; B29L 2031/752

(57) ABSTRACT

A method for manufacturing a vehicular sensor housing includes processing a metallic heat dissipating element to form an engagement structure at a first side of the heat dissipating element. With the processed heat dissipating element disposed in a mold, the mold is injected with an uncured plastic material to form a heat dissipating housing portion of the sensor housing. The uncured plastic material flows at least partially along the first side of the heat dissipating element and at least partially fills recesses between portions of the engagement structure. With the plastic material cured, the heat dissipating housing portion is joined to another portion of the sensor housing, and a portion of the first side of the heat dissipating element is exposed within the sensor housing and a portion of a second side of the heat dissipating element opposite the first side is exposed exterior of the sensor housing.

### CROSS REFERENCE TO RELATED APPLICATION

The present application claims the filing benefits of U.S. provisional application Ser. No. 63/689,066, filed Aug. 30, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular sensor unit, such as a radar sensor or a camera sensor or an electronic control unit (ECU) module, includes a plastic housing having a metallic heat dissipating element integrally formed with at least a portion of the housing. For example, a first side or portion of the heat dissipating element may be disposed within the housing and in thermally conductive connection with a heat-generating component within the housing (e.g., a sensor or processor disposed at a printed circuit board). A second side or portion of the heat dissipating element may be disposed exterior the housing for dissipating heat generated within the housing away from the housing.

A method of manufacturing the sensor housing may include processing a metallic heat dissipating element to form an engagement structure at a first side of the heat dissipating element. For example, a laser may be used to form the engagement structure. With the processed heat dissipating element disposed in a mold, the method may include injecting the mold with a liquid plastic material to form at least a portion of the vehicular sensor housing. The liquid plastic material flows along the first side of the heat dissipating element and at least partially fills recesses between portions of the engagement structure. With the plastic material cured, the heat dissipating element is joined to the vehicular sensor housing, and a second side of the heat dissipating element opposite the first side is at least partially exposed at an exterior of the vehicular sensor housing.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a radar sensor;

FIG. 2 is a sectional view of the radar sensor;

FIG. 3A is a sectional view of a heat dissipating element of the radar sensor prior to a pre-treatment process;

FIG. 3B is a sectional view of the heat dissipating element after the pre-treatment process; and

FIG. 3C is a sectional view of the heat dissipating element after being overmolded with the plastic material of the housing of the radar sensor.

### DESCRIPTION OF THE PREFERRED EMBODIMENTS

A vehicle sensing system and/or driver assist system or driving assist system and/or object detection system and/or alert system operates to capture sensing data exterior of the vehicle and may process the captured data to detect objects at or near the vehicle and in the predicted path of the vehicle, such as to assist a driver of the vehicle or a control for an autonomous vehicle in maneuvering the vehicle in a forward or rearward direction. The system includes a processor that is operable to receive sensing data from one or more sensors and provide an output, such as an alert or control of a vehicle system.

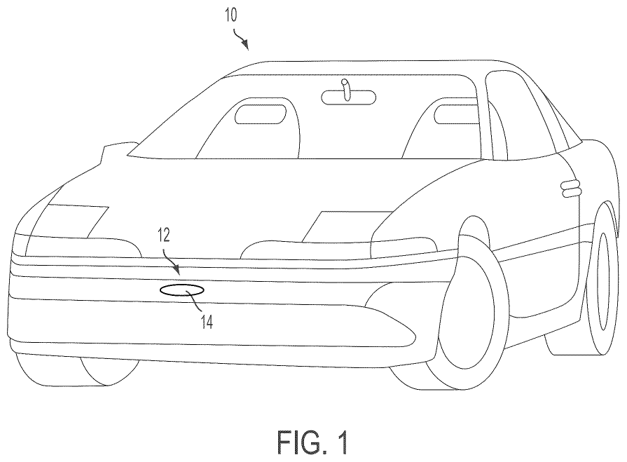

Referring now to the drawings and the illustrative embodiments depicted therein, a vehicle 10 (FIG. 1) includes a driving assistance system or sensing system 12 that includes at least one radar sensor unit, such as a forward facing radar sensor unit 14 (and the system may optionally include multiple exterior facing sensors, such as cameras, radar, or other sensors, such as a rearward facing sensor at the rear of the vehicle, and a sideward/rearward facing sensor at respective sides of the vehicle), which sense regions exterior of the vehicle. The sensing system 12 includes a control or electronic control unit (ECU) that includes a data processor that is operable to process data captured by the radar sensor(s). The sensing system may also include a radar sensor that includes a plurality of transmitters that transmit radio signals via a plurality of antennas. The radar sensor also includes a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driving assist system of the vehicle, with the driving assist system controlling at least one function or feature of the vehicle (such as to provide at least partially autonomous driving control of the vehicle) responsive to processing of the data captured by the radar sensors. The data transfer or signal communication from the sensor to the ECU may comprise any suitable data or communication link, such as a vehicle network bus or the like of the equipped vehicle.

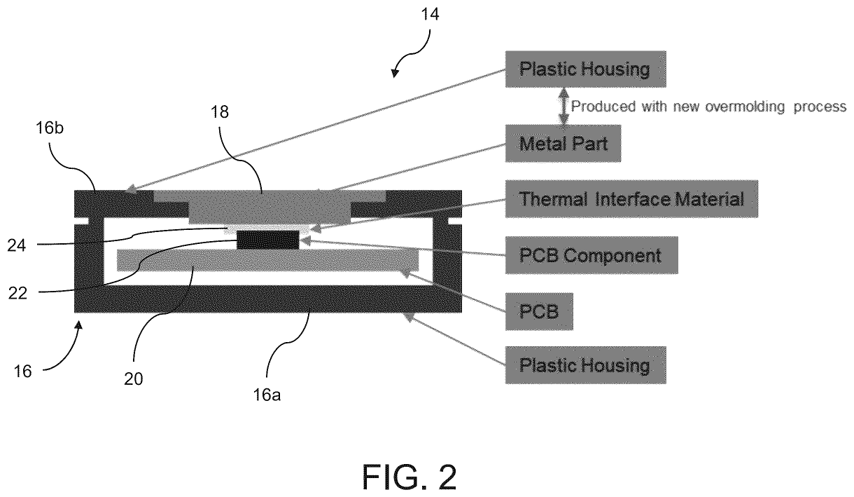

Referring to FIG. 2, the radar sensor unit 14 includes a housing 16 formed from a plastic material and that includes at least one integrated or embedded heat dissipating element 18 formed from a metallic material. In the illustrated example, the housing 16 includes a first housing portion 16a and a second housing portion 16b that is joined to the first housing portion 16a to define an interior compartment or interior portion of the housing 16. The metallic heat dissipating element 18 is disposed at the second housing portion or heat dissipating housing portion 16b and includes a first surface or portion exposed at the interior compartment of the housing 16 and includes a second surface or portion exposed at an exterior side of the housing 16. A printed circuit board (PCB) 20 is accommodated within the housing 16 and includes a heat-generating electronic component 22 (e.g., at least a portion of the radar sensor and/or a processor for processing the captured sensor data) in thermal conductive connection with the heat dissipating element 18. For example, a thermal interface material 24 may be disposed between the heat-generating electronic component 22 and the first portion of the heat dissipating element 18 exposed within the housing 16. During operation of the radar sensor 14, heat generated within the compartment of the housing 16 is at least partially dissipated exterior of the housing 16 via the heat dissipating element 18. Position of the heat dissipating element 18 at the housing 16 may correspond to the position of one or more heat-generating components within the housing 16.

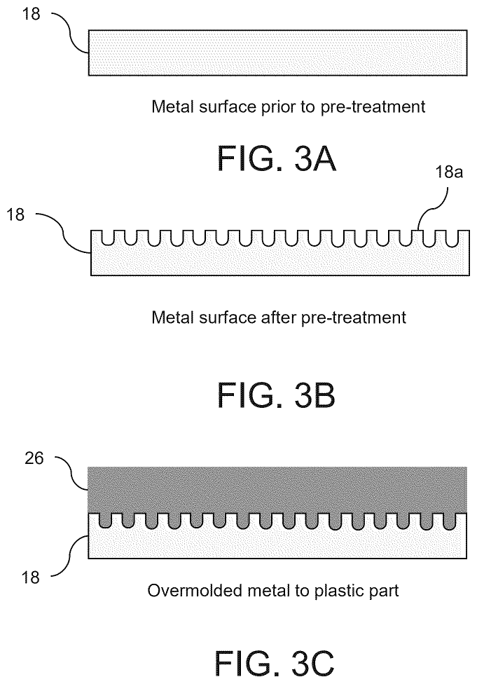

The metallic heat dissipating element 18 is overmolded by the plastic housing portion. That is, during manufacturing of the radar sensor 14, the heat dissipating element 18 may be placed in a mold and molten or liquid plastic material 26 may be injected into the mold to join the heat dissipating element with the plastic portion of the housing as the plastic material cures (FIGS. 3A-3C).

As shown in FIGS. 3A-3C, prior to injection molding, the heat dissipating element 18 undergoes a pre-treatment process. During the pre-treatment process, an overmolding surface or contact surface of the heat dissipating element 18 (FIG. 3A) is processed to form engagement structure 18a at the overmolding surface (FIG. 3B). For example, a laser may etch a plurality of channels or recesses or a textured pattern at the overmolding surface to define the engagement structure 18a. Thus, the engagement structure 18a and overmolding surface provide a series of ridges and valleys or other protrusions and recesses (such as, for example, a plurality of spaced apart raised bumps) configured to receive the molten plastic material 26. The engagement structure 18a may increase the surface area of the overmolding surface for improving connection between the heat dissipating element 18 and plastic material 26 after curing.

After the pre-treatment process, the heat dissipating element 18 may be placed in an injection molding tool and the heat dissipating element 18 may be overmolded with the plastic material 26 (FIG. 3C). The plastic material 26 may flow along the overmolding surface and fill the recesses and valleys defined by the engagement structure 18a of the heat dissipating element. Following curing, the plastic material 26 creates a form and force fit connection with the heat dissipating element 18.

When forming the heat dissipating housing portion 16b, plastic material 26 is overmolded at the heat dissipating element 18 such that the first surface or portion of the heat dissipating element 18 is exposed at a first side of the housing portion 16b and the second surface or portion of the heat dissipating element 18 is exposed at an opposite second side of the housing portion 16b. The first side of the housing portion 16b and the first surface of the heat dissipating element 18 may be configured to face the interior of the housing 16 and the second side of the housing portion 16b and the second surface of the heat dissipating element 18 may be configured to face exterior of the housing 16. That is, only a portion of the heat dissipating element 18 is overmolded by the plastic material 26 (with the engagement structure 18a formed at the overmolded portion) so that part of the heat dissipating element 18 is exposed at opposing sides of the housing portion 16b. The overmolded portions of the heat dissipating element 18 may include parts of the first surface of the heat dissipating element 18 and/or parts of the second surface of the heat dissipating element 18. The engagement surface 18a may be formed both at portions that are overmolded by the plastic material 26 and portions that are not overmolded by the plastic material 26, such as to increase surface area of the exposed portions of the heat dissipating element 18 that are capable of dissipating heat away from the sensor unit 14.

In the illustrated example of FIG. 2, the engagement structure 18a is formed at a perimeter edge region of one side of the heat dissipating element 18. This perimeter edge region of the heat dissipating element 18 is overmolded by the plastic material 18 and a central region of the heat dissipating portion 18 is not overmolded. With the second housing portion 16b joined to the first housing portion 16a, the central region extends toward the interior of the housing 16 and thermally interfaces with one or more heat-generating components 22 within the housing 16, such as by engaging the component 22 and/or thermal interface material 24 engaging the component 22.

Thus, the heat dissipating element 18 may be overmolded with the plastic housing 16 without need for special additives or coatings for adhesion. A waterproof connection may be achieved. Pre-treatment of the metal surface by laser allows the metal surface to be structured and the plastic flows into this structured surface during overmolding, creating a mechanical fixation between both parts. The heat dissipating element 18 may improve heat dissipation from the PCB 20 and other heat-generating components within the housing 16 and exterior of the housing 16. Heat dissipation may be poor with a housing having only two plastic components. Adding the metallic part in the area of the heat generating component helps to conduct heat to the outside.

Although described herein as a method for manufacturing a housing for a radar sensor module, it should be understood that characteristics of the disclosure may be suitable for manufacturing of any sensor module, such as any vehicular sensor module configured for use interior or exterior of a vehicle, such as a camera, a lidar sensor, an ultrasonic sensor, and the like, or a housing for a control module or electronic control unit (ECU) module of the vehicle. That is, the heat dissipating element 18 is processed to form the engagement structure 18a at least at one side of the heat dissipating element 18. This allows the heat dissipating element 18 to be overmolded with plastic material 26 to form a housing 16, and the housing 16 may comprise the housing of any suitable sensor or control module, and the heat dissipating element 18 may thermally interface with heat-generating electronic circuitry of any suitable sensor or control module.

For example, a camera assembly or module may utilize aspects of the cameras and connectors described in U.S. Pat. Nos. 11,801,795; 11,750,905; 11,711,598; 10,272,857; 10,250,004; 10,230,875; 10,142,532; 9,621,769; 9,277,104; 9,077,098; 8,994,878; 8,542,451 and/or 7,965,336, and/or U.S. Publication Nos. US-2009-0244361; US-2013-0242099; US-2014-0373345; US-2015-0124098; US-2015-0222795; US-2015-0327398; US-2016-0243987; US-2016-0268716; US-2016-0286103; US-2016-0037028; US-2017-0129419; US-2017-0133811; US-2017-0201661; US-2017-0280034; US-2017-0295306 and/or US-2018-0098033, which are hereby incorporated herein by reference in their entireties.

Characteristics of the disclosure may be suitable with other types of sensors, such as radar sensors or imaging radar sensors or lidar sensors or the like, such as to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A method for manufacturing a vehicular sensor housing, the method comprising:
providing a metallic heat dissipating element;
processing the metallic heat dissipating element to form an engagement structure at a first side of the metallic heat dissipating element;
with the processed metallic heat dissipating element disposed in a mold, injecting an uncured plastic material into the mold to form a heat dissipating housing portion of the vehicular sensor housing, wherein the uncured plastic material flows at least partially along the first side of the metallic heat dissipating element and at least partially fills recesses between portions of the engagement structure at the first side of the metallic heat dissipating element; and
wherein, with the plastic material cured, the heat dissipating housing portion is joined to another portion of the vehicular sensor housing, and wherein, with the heat dissipating housing portion joined to the other portion of the vehicular sensor housing, (i) a portion of the first side of the metallic heat dissipating element is exposed within the vehicular sensor housing and (ii) at least a portion of a second side of the metallic heat dissipating element that is opposite the first side is exposed exterior of the vehicular sensor housing.

2. The method of claim 1, wherein processing the metallic heat dissipating element comprises laser etching at least part of the first side of the metallic heat dissipating element to form the engagement structure at the first side of the metallic heat dissipating element.

3. The method of claim 1, wherein the engagement structure comprises a plurality of protrusions extending from the first side of the metallic heat dissipating element.

4. The method of claim 1, wherein the engagement structure is at a perimeter region of the first side of the metallic heat dissipating element.

5. The method of claim 4, wherein the portion of the first side of the metallic heat dissipating element exposed within the vehicular sensor housing comprises a central region of the first side of the metallic heat dissipating element that is inboard of the perimeter region.

6. The method of claim 1, wherein the portion of the first side of the metallic heat dissipating element exposed within the vehicular sensor housing is configured to thermally interface with a heat-generating component disposed within the vehicular sensor housing.

7. The method of claim 1, wherein the vehicular sensor housing comprises a radar housing.

8. The method of claim 1, wherein the vehicular sensor housing comprises a camera housing.

9. The method of claim 1, wherein the vehicular sensor housing comprises an electronic control unit (ECU) module housing.

10. A vehicular sensor, the vehicular sensor comprising:
a vehicular sensor housing comprising a first housing portion and a second housing portion, wherein the first housing portion and the second housing portion are joined together;
a sensor accommodated by the vehicular sensor housing;
wherein the first housing portion comprises a plastic portion overmolded partially over a metallic heat dissipating element;
wherein the metallic heat dissipating element comprises a first side and a second side opposite the first side, and wherein an engagement structure is formed at the first side of the metallic heat dissipating element;
wherein the plastic portion, when overmolded partially over the metallic heat dissipating element, at least partially fills recesses between portions of the engagement structure formed at the first side of the metallic heat dissipating element;
wherein, with the plastic portion overmolded partially over the metallic heat dissipating element, an overmolded portion of the first side of the metallic heat dissipating element is overmolded by the plastic portion and an exposed portion of the first side of the metallic heat dissipating element is not overmolded by the plastic portion; and
wherein, with the first housing portion joined to the second housing portion of the vehicular sensor housing, (i) the exposed portion of the first side of the metallic heat dissipating element is exposed within the vehicular sensor housing and (ii) the second side of the metallic heat dissipating element that is opposite the first side is at least partially exposed exterior of the vehicular sensor housing.

11. The vehicular sensor of claim 10, wherein at least part of the first side of the metallic heat dissipating element is laser etched to form the engagement structure at the first side of the metallic heat dissipating element.

12. The vehicular sensor of claim 10, wherein the engagement structure comprises a plurality of protrusions extending from the first side of the metallic heat dissipating element.

13. The vehicular sensor of claim 10, wherein the overmolded portion of the first side of the metallic heat dissipating element is at a perimeter region of the first side of the metallic heat dissipating element.

14. The vehicular sensor of claim 13, wherein the exposed portion of the first side of the metallic heat dissipating element comprises a central region of the first side of the metallic heat dissipating element that is inboard of the perimeter region.

15. The vehicular sensor of claim 10, wherein the exposed portion of the first side of the metallic heat dissipating element is configured to thermally interface with a heat-generating component disposed within the vehicular sensor housing.

16. The vehicular sensor of claim 10, wherein the sensor comprises at least one selected from the group consisting of (i) a radar transmitter and (ii) a radar receiver.

17. The vehicular sensor of claim 10, wherein the sensor comprises an imaging sensor.

18. The vehicular sensor of claim 10, wherein, with the plastic portion overmolded partially over the metallic heat dissipating element, an overmolded portion of the second side of the metallic heat dissipating element is overmolded by the plastic portion and an exposed portion of the second side of the metallic heat dissipating element is not overmolded by the plastic portion.

19. A method for manufacturing a vehicular sensor housing, the method comprising:
providing a metallic heat dissipating element;
laser etching the metallic heat dissipating element to form an engagement structure at a first side of the metallic heat dissipating element, and wherein the engagement structure is at a perimeter region of the first side of the metallic heat dissipating element;
with the laser etched metallic heat dissipating element disposed in a mold, injecting an uncured plastic material into the mold to form a heat dissipating housing portion of the vehicular sensor housing, wherein the uncured plastic material flows at least partially along the first side of the metallic heat dissipating element and at least partially fills recesses between portions of the engagement structure at the first side of the metallic heat dissipating element;
wherein, with the plastic material cured, the heat dissipating housing portion is joined to another portion of the vehicular sensor housing, and wherein, with the heat dissipating housing portion joined to the other portion of the vehicular sensor housing, (i) a portion of the first side of the metallic heat dissipating element is exposed within the vehicular sensor housing and (ii) at least a portion of a second side of the metallic heat dissipating element that is opposite the first side is exposed exterior of the vehicular sensor housing; and
wherein the portion of the first side of the metallic heat dissipating element exposed within the vehicular sensor housing is configured to thermally interface with a heat-generating component disposed within the vehicular sensor housing.

20. The method of claim 19, wherein the portion of the first side of the metallic heat dissipating element exposed within the vehicular sensor housing comprises a central region of the first side of the metallic heat dissipating element that is inboard of the perimeter region.

21. The method of claim 19, wherein the vehicular sensor housing comprises one selected from the group consisting of (i) a radar housing, (ii) a camera housing and (iii) an electronic control unit (ECU) module housing.
